(19) United States
(12) Patent Application Publication
(10) Pub. No.: US 2007/0282461 A1
(43) Pub. Date: Dec. 6, 2007

(54) Single Winding Back Emf Sensing Brushless Dc Motor

(76) Inventor: Jonathan David Harwood, Auckland (NZ)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 10/581,965

(22) PCT Filed: Dec. 21, 2004
(86) PCT No.: PCT/NZ04/00327

§ 371 Date: Apr. 20, 2007

(30) Foreign Application Priority Data
Dec. 22, 2003 (NZ) 530370

(51) Int. Cl. H02P 6/18; G05B 11/01; H02K 29/00

(52) U.S. Cl. 700/14; 310/234; 310/68 B; 318/254; 417/44.1; 700/282

(57) ABSTRACT

A method and controller for electronically commutating a permanent magnet brushless dc motor (21) under closed loop control where current is commutated (22) through successive combinations of two out of three stator windings to produce a rotating flux. Commutations are determined by each 60° angular position of the rotor by sensing the back EMF (24) induced in only one of the three stator windings whenever that winding has no applied current flowing in it to determine the 0° and 180° positions and extrapolating the 60°, 120°, 240° and 300° positions by dividing the time interval therebetween by a factor of 3.

### TECHNICAL FIELD

This invention relates to electronically controlled brushless DC motors (having permanent magnet rotors) and in particular, but not solely, to three winding motors for fractional horsepower applications such as in home appliances and healthcare equipment. In a laundry machine such electronically controlled motors may be used to power the wash and spin motion of an agitator or drum and/or the wash bowl drain and recirculating pumps.

### PRIOR ART

Methods of controlling electronically commutated brushless DC motors have been disclosed in U.S. Pat. No. 4,495,450 (Tokizaki et al, assigned to Sanyo Electric Co Ltd) and for use in home appliances and in particular laundry washing machines in U.S. Pat. No. 4,540,921 (Boyd et al, assigned to General Electric Company), U.S. Pat. No. 4,857,814 (Duncan et al, assigned to Fisher & Paykel Limited). As background to the present invention some of the basic electronically controlled motor (ECM) concepts described in these patents is summarised below with reference to FIGS. 1 and 2.

A three phase (three stator windings) DC motor is shown schematically in FIG. 1 with commutation switches which could be IGBT power FETs. By turning on upper switch 1 for phase A and lower switch 2 for phase B, a static magnetic field will be created in the stator. By turning off lower switch 2 for phase B and turning on lower switch 3 for phase C, this magnetic field will move in a clockwise direction. Turning off upper switch 1 for phase A and turning on upper switch 4 for phase B will cause the magnetic field to continue to move in the clockwise direction. By repeating this “rotation” of the commutation switches the magnetic field in the stator will tend to rotate at the same speed as the switching of the switches. Other patterns of commutation switch activation could also lead to clockwise rotation, but the one described produces maximum motor torque.

It will be noted that in the example described only two windings are energised at any one time (“two phase firing”). A full pattern of the six switch states for two phase firing clockwise rotation is shown in FIG. 2. This can be interpreted as follows. To obtain maximum torque in the motor the connections would be A+ and C− to the 60 degree angle, then B+ and C− to the 120 degree angle, then B+ and A− to 180 degree angle, then C+ and A− to the 240 degree angle, then C+, B− to the 300 degree angle, and then A+ and B− to the 360 degree angle, the sequence commencing at A+ and C− again. Thus there is a sequence of six different switch patterns and each goes to 60 degree angle of rotation giving a total of 360 degrees in rotation.

Counter-clockwise rotation of the motor is achieved by reversing the switching pattern sequence of the commutation switches.

As mentioned in the example described, for creating a rotating magnetic field in the stator only two phases have current intentionally flowing in them at once. “Three phase firing” is also possible, but two phase firing has an advantage in that at any time one winding has no intentional motor drive current flowing through it. In the cited patents this temporarily unused winding is sensed for any voltage induced by the rotating permanent magnet rotor to provide an indication of rotor position. The induced voltage is due to back electromotive force (BEMF).

The sensed BEMF waveform is cyclical and varies between trapezoidal and a near sinusoid. The “zero crossings” of this waveform are due to the edge of the permanent magnet poles and provide a consistent point on the rotor to track its rotational position.

When such a DC brushless motor is running, each commutation needs to be synchronous with the position of the rotor. As soon as the BEMF signal described above passes through zero, a decision is made to commutate to the next switching pattern to ensure continued rotation is accomplished. Switching must only occur when the rotor is in an appropriate angular position. This results in a closed loop feedback system for controlling speed. The commutation frequency will keep pace with the rotor due to the closed loop feedback from the BEMF sensor.

Acceleration or de-acceleration of the rotor is accomplished by either increasing or decreasing the strength of the rotating magnetic field in the stator (by pulse width modulation (PWM) techniques) since the force on the rotor is proportional to the strength of the magnetic field. Maintaining a pre-determined speed under constant load involves controlling the strength of the magnetic field in the stator to ensure that the desired commutation rate is maintained. To maintain a predetermined speed of rotation under varying loads requires corresponding alteration of the strength of the magnetic field in the stator to compensate for changes in the load on the rotor.

The use of BEMF sensing to determine rotor position has many advantages, of which one is obviating the need for external sensors, such as Hall effect sensors. But prior art ECMs using BEMF sensing have the problem in that the BEMF digitisers use a relatively high number of components, particularly high voltage resistors, which require excessive space on the associated printed circuit boards and increase cost.

It is therefore an object of the present invention to provide an electronically controlled motor system which goes some way towards overcoming the above disadvantages.

### DISCLOSURE OF INVENTION

Accordingly in one aspect the present invention consists in a method of commutating a permanent magnet rotor brushless dc motor having three phase stator windings for producing rotating magnetic flux comprising the steps of:

commutating current to successive combinations of two of said windings to cause flux rotation in a desired direction,

sensing in only one of said windings the periodic back EMF induced by rotation of the permanent magnet rotor,

said sensing being enabled in the two out of six 60° intervals when winding has no current commutated to it,

digitising said sensed back EMF signal in said one winding by detecting the zero-crossings of said signal,

determining a half period time of said signal by obtaining a measure of the time between the pulse edges in the digitised signal which are due to zero crossings,

from said half period time deriving the 60° flux rotation time (commutation period) and causing each said commutation to occur at times which are substantially defined by each logic transition in said digitised signal due to zero crossings and at the derived 60° and 120° angles of flux rotation which follow said zero crossings.

In a second aspect the invention consists in an electronically commutated brushless dc motor comprising:

a stator having a plurality of windings adapted to be selectively commutated to produce a rotating magnetic flux,

a rotor rotated by said rotating magnetic flux,

a direct current power supply having positive and negative output nodes;

commutation devices connected to respective windings which selectively switch a respective winding to said output nodes in response to a pattern of control signals which leave at least one of said windings unpowered at any one time while the other said windings are powered so as to cause stator flux to rotate in a desired direction;

digitising means coupled to one only of said windings for digitising the back EMF induced in that winding by detecting the zero crossings of said back EMF signal; and

a microcomputer operating under stored program control, said microcomputer having an input port for said digitized back EMF signal and output ports for providing said commutation switch control signals, said microcomputer determining from said digitised back EMF signal a measure of the half period thereof by measuring the time between the pulse edges in the digitised signal which are due to zero-crossings, said microcomputer effectively dividing said determined half period by a number equal to the number of stator windings to produce a commutation period, said microcomputer producing commutation control signals at said output ports to cause the stator flux to rotate whereby switchings of said commutation devices are timed to occur at each zero-crossing of said back EMF signal and at intervals therebetween substantially equal to said commutation period.

In a third aspect the invention consists in a washing appliance pump including:

a housing having a liquid inlet and a liquid outlet,

an impeller located in said housing, and

an electronically commutated motor which rotates said impeller, said electronically commutated motor comprising:

a stator having a plurality of windings adapted to be selectively commutated,

a rotor driveably coupled to said impeller;

a direct current power supply having positive and negative output nodes;

commutation devices connected to respective windings which selectively switch a respective winding to said output nodes in response to a pattern of control signals which leave at least one of said windings unpowered at any one time while the other said windings are powered so as to cause stator flux to rotate in a desired direction;

digitising means coupled to one only of said windings for digitising the back EMF across that winding by detecting the zero crossings of said back EMF signal; and

a microcomputer operating under stored program control, said microcomputer having an input port for said digitized back EMF signal and output ports for providing said commutation switch control signals, said microcomputer determining from said digitised signal a measure of the half period of the back EMF signal by measuring the time between the pulse edges in the digitised signal which are due to zero-crossings, said microcomputer effectively dividing said determined half period by a number equal to the number of stator windings to produce a commutation period, said microcomputer producing commutation control signals at said output ports to cause the stator flux to rotate whereby switchings of said commutation devices are timed to occur at each back EMF signal zero-crossing and at intervals therebetween substantially equal to said commutation period.

### BRIEF DESCRIPTION OF DRAWINGS

FIG. 1 is a simplified circuit diagram of an electronically commutated three winding brushless DC motor,

FIG. 2 shows the sequence of commutation switch states for two phase firing to cause clockwise rotation of the motor of FIG. 1,

FIG. 3 is a block circuit diagram of an electronically commutated brushless DC motor according to the present invention,

FIG. 4(a) is a waveform diagram showing the drive currents flowing through the three windings of the motor,

FIG. 4(b) is a waveform diagram showing the voltage across the single sensed winding of the motor of FIG. 3,

FIG. 4(c) is a waveform diagram showing the digitised form of the voltage waveform shown in FIG. 4(b),

FIG. 5 is a circuit diagram for the back EMF digitiser shown in FIG. 3, and

FIG. 6 shows diagrammatically the application of the present motor driving a drain and/or recirculation pump in a clothes washing machine.

### BEST MODES FOR CARRYING OUT THE INVENTION

Preferred implementations of the invention will now be described.

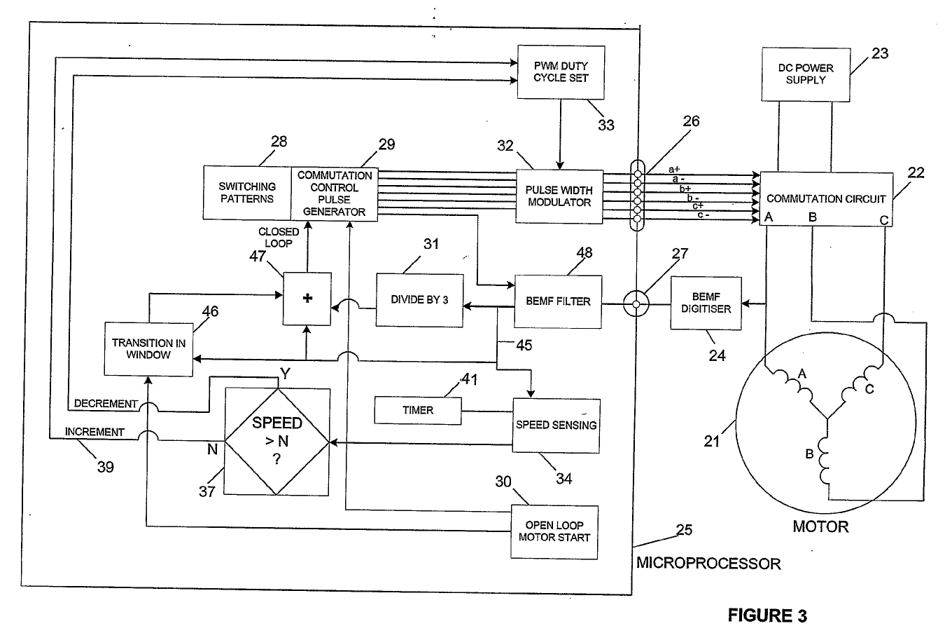

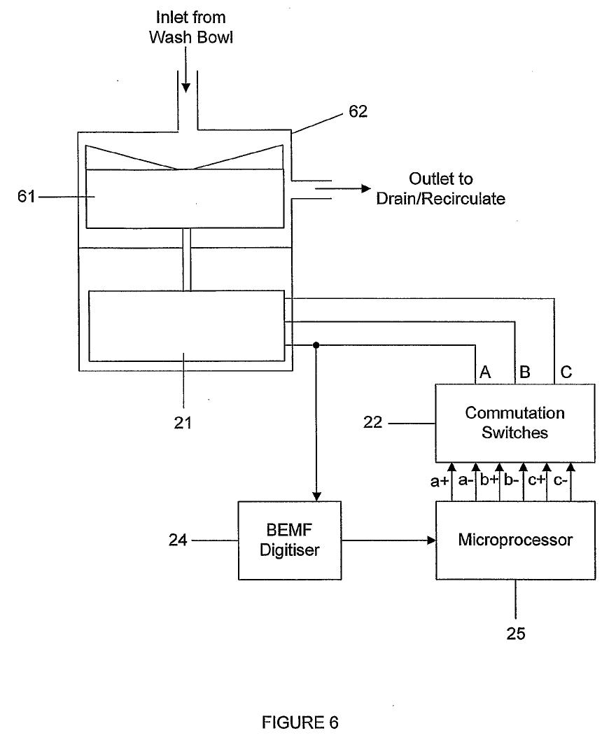

FIG. 3 shows one preferred form of the electronically commutated motor of the present invention in block diagram form. The main hardware blocks are a permanent magnet three winding motor 21, motor winding commutation circuit 22, DC power supply 23, back EMF digitiser 24 and a programmed microcomputer 25. In the preferred application where the motor 21 drives an impeller 61 in a pump 62 in a washing appliance (see FIG. 6) the microcomputer 25 will usually be the appliance microprocessor which will be responsible for all other appliance control functions; including control of a main motor for spin and wash actions in the case of a clothes washing machine.

The present electronically commutated motor (ECM) system is described in relation to a preferred form of motor having a stator with three windings (or phases) A, B and C and six salient poles. Other stator configurations could be used. The motor has a four pole permanent magnet rotor, although a different number of poles could be adopted. The windings A, B and C are connected together in star configuration in this embodiment as indicated in FIG. 3.

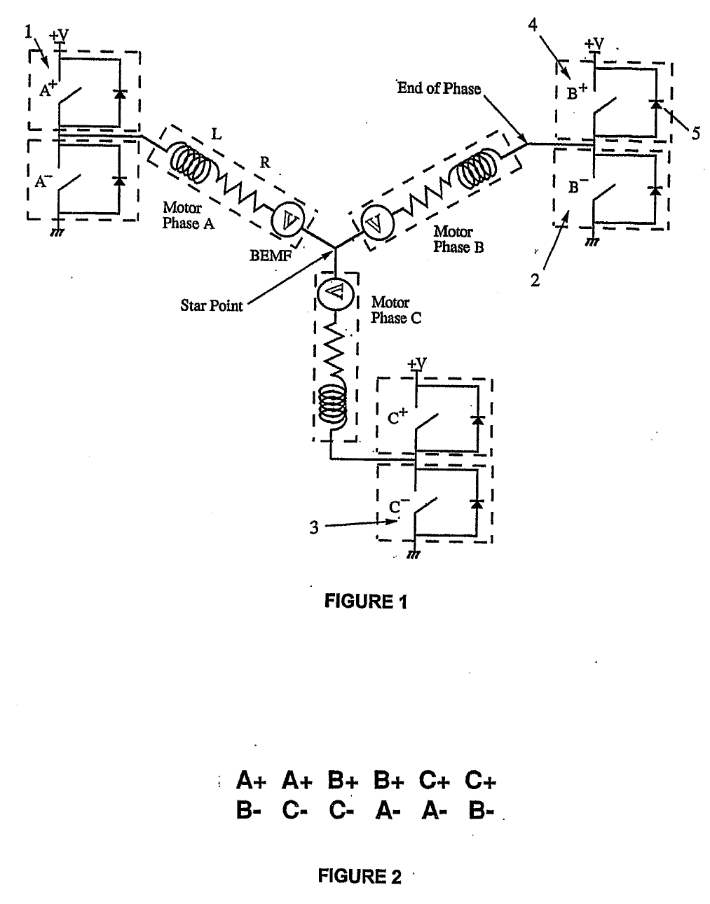

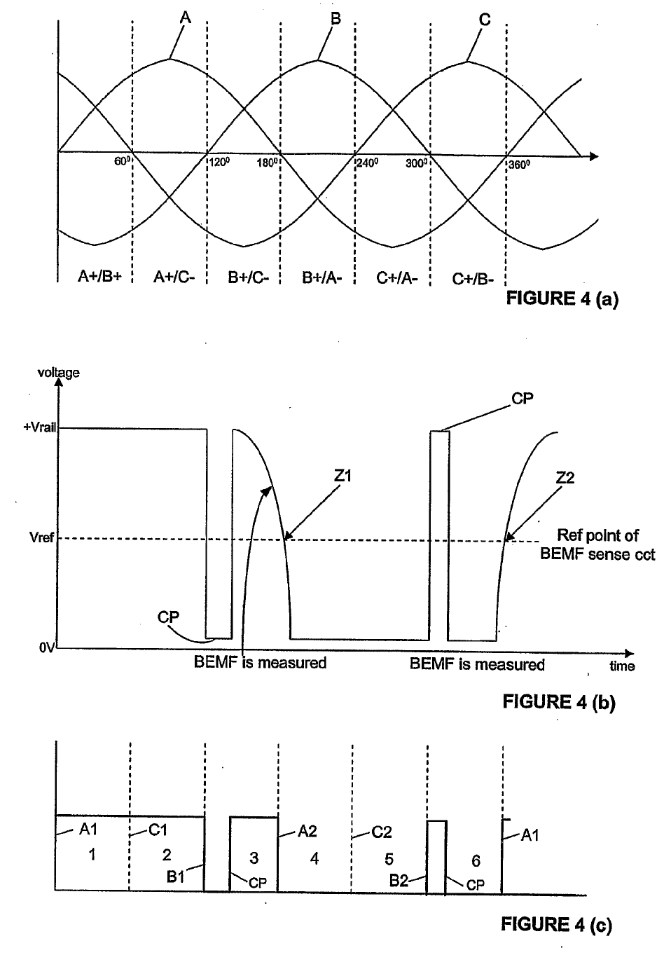

Commutation circuit 22 includes pairs of switching devices in the form of IGBTs or power field effect transistors (FETs) which are connected across the direct current power supply 23 in a bridge configuration to commutate each of windings A, B and C in the manner already described with reference to FIGS. 1 and 2 where they are designed A+/A−, B−/B− and C+/C−. The winding inductances ensure the current that results is approximately sinusoidal as shown in FIG. 4(a). Each of the six switching devices making up the upper and lower switches for each motor phase is switched by gate signals a+, a−, b+, b−, c+, c− produced by microcomputer 25. DC power supply 23 supplies the DC voltage which is applied across each switching device pair.

BEMF digitiser 24 receives an input signal from the switched end of motor phase A for the purposes of monitoring the back EMF induced by rotation of the rotor which provides rotor position information. According to this invention only the output from a single motor winding (in this example winding A) is used for this purpose. BEMF digitiser 24 supplies at its output a digital signal (see FIG. 4(c)) representative of the analogue signal at its input (see FIG. 4(b)) and derives the logic levels by comparator techniques as will be described. The digital output signal will include periodic logic transitions A1 and A2 which correspond to the “zero crossings” Z1 and Z2 of the analogue BEMF voltage induced in phase winding A as a rotor pole passes a winding pole associated with that phase.

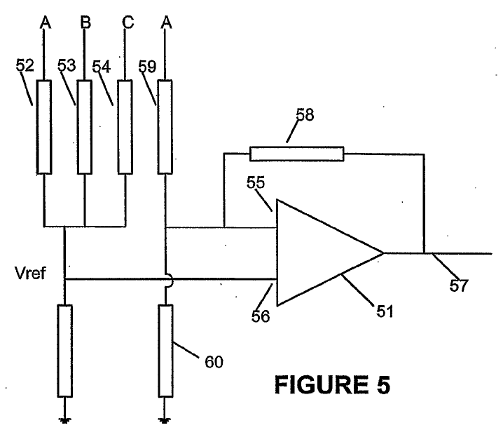

The circuit for the BEMF digitiser 24 is shown in FIG. 5. A comparator 51 is provided with a reference voltage V_{ref} on input 56 which is the potential of the star point of the star connected stator windings A, B and C. This is derived by algebraically summing the potentials at the accessible switched ends of stator windings A, B and C. Resistors 52 to 54 are used to combine the winding voltages.

The two state output 57 of comparator 51 is fed to microprocessor port 27. As already mentioned it is the back EMF across only winding A (when it is not being commutated) which is used for rotor position and other control purposes. Since commutation is determined by the microprocessor it is always known when winding A is not conducting motor current and thus a time window is established within which rotor zero-crossings from the comparator are monitored.

The voltage from motor winding A is applied to input 55 of comparator 51 via a potential divider formed by resistors 59 and 60. When the level of the winding A voltage signal at input 55 exceeds V_{ref} (establishing a back EMF zero-crossing point) the output 57 of the comparator 51 changes state (see FIG. 4(c)) and thereby digitises sufficiently large excursions of the winding voltage signal.

Referring to FIG. 3 the microcomputer software functions will now be described. A start routine 30 causes the commutation control pulse generator 29 to produce pulses on output ports a+ to c− reflecting the switch patterns shown in FIG. 2. Each of the six switch patterns is successively retrieved in turn from memory 28. Control pulses for the commutation switches are synthesised by the commutation control pulse generator routine 29 which includes a pointer value which points to the location of the switching state pattern in table 28 which is required to produce the next commutation for the particular direction of rotation required of motor 21. Six commutation drive signals are required to be synthesised although only two of these change state on each commutation. The switch patterns are cycled continuously at a low speed to produce a stator flux which rotates at the same speed to induce the rotor to rotate and synchronise with that speed.

The digitised phase A back EMF signal 45 is monitored by routine 46 to seek the occurrence of a logic transition A1 or A2 in the expected time window which would indicate synchronism of the rotor. Since the microcomputer is controlling commutation in open loop mode it can be programmed to monitor for A1 or A2 transitions in a time window established around the zero crossing of the current in phase A. That a logic transition is one due to zero-crossing of the back EMF is tested by polling at time increments for a logic pattern 110 or a logic pattern 001. An occurrence of a transition A1 or A2 in the established time windows will indicate the rotor is rotating in synchronism with the rotating stator field.

The next commutation can immediately be triggered on detecting the BEMF transition using the next switch pattern in memory as indicated by a pointer. The possibility that the back EMF transition has occurred just prior to the monitoring time window is also used as an indication of rotor synchronisation. That is if a change of logic state is detected at the start of the time window a short time-out routine is initiated, eg 2 mS, and if the logic state is unchanged after the 2 mS rotor synchronisation is assumed and the next commutation switch pattern fired. When, as stated above, a commutation is initiated following the 2 mS timeout routine the next commutation, rather than occurring (A2-A1)/3 later is initiated after a shorter fixed delay, eg 2 mS. This is based on the assumption that if a rotor pole has passed phase a winding just before the time window opens then the rotor may be rotating faster than the open loop commutation period and commutation to the next switch pattern should be advanced.

Other means of checking for rotor synchronism during the open loop startup phase may be used.

Once rotor synchronism has been detected commutation control is triggered by the logic transitions in the back EMF signal at input port 27 in a closed loop mode and the start routine exited. For phase A the logic transitions A1 and A2 in signal 45 are directly used. Triggers for the commutation control pulse generator 29 for phases B and C must be derived since the zero crossing points of the back EMF signal in phases B and C are not detected. As can be seen from FIG. 4, with a three phase motor, current must be commutated to phases B and C at two instants intermediate of the commutation of current to phase A at times corresponding to transitions A1 and A2, namely at the 60°, 120°, 240° and 300° points which correspond to times C1, B1, C2 and B2 shown dotted in FIG. 4(c).

In the present invention these commutation times are derived by extrapolation. This is done by measuring the time between the previous commutations of phase A, for example the time between A1 and A2, and effectively dividing that by 3 in routine 31 by multiplying by ⅓ and ⅔ respectively. These calculations are used to generate commutation triggers at A1+(A2-A1)/3 for phase C (“C1”), A1+(A2-A1)·⅔ for phase B (“B1”), etc, in routine 47 which together with A1 and A2 produces a full set of triggers for commutation control pulse generator 29.

In the preferred embodiment the measured time between transitions A1 and A2 which is used to calculate intermediate commutations is a moving average of previous zero crossing periods determined by a forgetting factor filter.

In practice, for various reasons, the calculated commutations of phases B and C may be shifted from the precise (A2-A1)/3 times. For example, when a phase is disconnected from the DC supply by a commutation, switch current due to the inductance of the winding will flow through the freewheel diode connected in parallel with the commutation switch (see FIG. 1) which has just been switched off. The current pulse so produced is reflected in the back EMF signal as shown in FIG. 4(b) and designated CP. The effect on the digitised back EMF signal can be seen in FIG. 4(c). Since the current pulse duration is a function of the motor current (see U.S. Pat. No. 6,034,493) at higher motor currents the current pulse can potentially be of sufficient duration as to bracket the times where transitions A1 and A2 occur and thus mask those transitions. In order to avoid this it is an optional feature of the present invention to advance one of the calculated commutation times C1 or B1 and C2 or B2. This ensures the current pulse CP in signal 45 has terminated before transitions A1 and A2.

As an example, the ⅔ intermediate commutations may be advanced by 300 μS. This ensures the current pulse CP is complete before the next zero crossing occurs. The motor may thereby be run at higher levels of current and still maintain synchronism.

Further, as is known from the prior art all commutation times could be advanced to allow for current build-up time and thereby increase torque.

Speed control of the motor when running under closed loop control is achieved in the manner disclosed in U.S. Pat. No. 6,034,493. That is, the synthesised commutation control pulses are pulse width modulated when being supplied to the commutation circuit 22. A routine 32 imposes a duty cycle on the pulses which are synthesised by routine 29 appropriate to the commutation devices through which motor current is to flow in accordance with the present value of duty cycle held in location 33. The duty cycle is varied to vary the applied voltage across the stator windings to accelerate and decelerate motor 21 and to accommodate varying loads on the rotor since rotor torque is proportional to motor current and this is determined by the duty cycle of the pulse width modulation (PWM). In some applications it may be sufficient to only pulse width modulate the lower bridge devices in the commutation circuit 22.

The PWM may be optionally also be varied for the purpose of maintaining motor synchronisation in extreme situations. The duration between the end of the current pulse CP and the next zero-crossing is measured and if it falls below a predetermined margin (say 300 μS) the PWM determined excitation voltage is reduced until the set margin is regained. Thus under a rapid increase in motor load motor power is decreased to avoid loss of synchronism.

The electronically commutated motor of the present invention achieves the known advantages of rotor position determination using back EMF sensing in a manner which minimises components for the back EMF digitiser and therefore required printed circuit board area. In addition the number of microprocessor inputs required and processor loading time are both reduced. These advantages facilitate an economically viable motor for intelligent pumps for use in clothes washing machines and dishwashers.

1. A method of electronically commutating a permanent magnet rotor brushless dc motor having three phase stator windings for producing rotating magnetic flux comprising the steps of:
commutating current to successive combinations of two of said windings to cause flux rotation in a desired direction,
sensing in only one of said windings the periodic back EMF induced by rotation of the permanent magnet rotor,
said sensing being enabled in the two out of six 60° intervals of flux rotation when the sensed winding has no current commutated to-it,
digitising said sensed back EMF signal in said one winding by detecting the zero-crossings of said signal,
determining a half period time of said signal by obtaining a measure of the time between the pulse edges in the digitised signal which are due to zero crossings,
from said half period time deriving the 60° flux rotation time (commutation period) and causing each said commutation to occur at times which are substantially defined by each logic transition in said digitised signal due to zero crossings and at the derived 60° and 120° angles of flux rotation which follow said zero crossings.

2. A method according to claim 1 wherein said derived commutation times are determined by calculating one third and two thirds respectively of said half period time.

3. A method according to either of claims 1 or 2 wherein said half period is a moving average of a succession measured times between zero-crossings.

4. A method according to claim 1 wherein the 120° flux angle commutations are advanced by a predetermined time.

5. An electronically commutated brushless dc motor comprising:
a stator having a plurality of windings adapted to be selectively commutated to produce a rotating magnetic flux,
a rotor rotated by said rotating magnetic flux;
a direct current power supply having positive and negative output nodes;
commutation devices connected to respective windings which selectively switch a respective winding to said output nodes in response to a pattern of control signals which leave at least one of said windings unpowered at any one time while the other said windings are powered so as to cause stator flux to rotate in a desired direction;
digitising means coupled to one only of said windings for digitising the back EMF induced in that winding by detecting the zero crossings of said back EMF signal; and
a microcomputer operating under stored program control, said microcomputer having an input port for said digitized back EMF signal and output ports for providing said commutation switch control signals, said microcomputer determining from said digitised back EMF signal a measure of the half period thereof by measuring the time between the pulse edges in the digitised signal which are due to zero-crossings, said microcomputer effectively dividing said determined half period by a number equal to the number of stator windings to produce a commutation period, said microcomputer producing commutation control signals at said output ports to cause the stator flux to rotate whereby switchings of said commutation devices are timed to occur at each zero-crossing of said back EMF signal and at intervals therebetween substantially equal to said commutation period.

6. A motor according to claim 5 wherein said microcomputer is programmed to switch said commutation devices at intervals between said zero-crossings of said back EMF signal which are calculated as one third and two thirds respectively of said measure of half period time.

7. A motor according to claim 5 wherein said microcomputer is programmed to provide said measure of half period time by calculating a moving average of successive measured times between pulse edges in said digitised signal which are due to zero-crossings.

8. A motor according to claim 6 wherein said microcomputer is programmed to subtract a predetermined time from said calculated two thirds of said measure of half period time to produce an advanced time to switch said commutation devices at said advanced time.

9. A motor according to claim 5 including:
freewheel diodes connected in parallel with each commutation device, a pulse width modulator which modulates said commutation switch control signals with a controllable duty cycle to vary the effective voltage applied from said direct current power supply to said stator windings, and wherein said microcomputer is programmed to:
(1) monitor the trailing edge of a pulse in the digitised back EMF due to current flowing through a free wheel diode when said sensed winding has been disconnected from said direct current supply,
(2) calculate the time interval between the trailing edge of said pulse and the next detected zero-crossing the in back EMF signal, and
(3) if said calculated time interval is less than a pre-stored value, altering the duty cycle of said pulse width modulation to reduce the voltage applied to said stator windings.

10. A washing appliance pump including:
a housing having a liquid inlet and a liquid outlet,
an impeller located in said housing, and
an electronically commutated motor which rotates said impeller, said electronically commutated motor comprising:
a stator having a plurality of windings adapted to be selectively commutated,
a rotor driveably coupled to said impeller; a direct current power supply having positive and negative output nodes;
commutation devices connected to respective windings which selectively switch a respective winding to said output nodes in response to a pattern of control signals which leave at least one of said windings unpowered at any one time while the other said windings are powered so as to cause stator flux to rotate in a desired direction;
digitising means coupled to one only of said windings for digitising the back EMF included in that winding by detecting the zero crossings of said back EMF signal; and
a microcomputer operating under stored program control, said microcomputer having an input port for said digitized back EMF signal and output ports for providing said commutation switch control signals, said microcomputer determining from said digitised back EMF signal a measure of the half period thereof by measuring the time between the pulse edges in the digitised signal which are due to zero-crossings, said microcomputer effectively dividing said determined half period by a number equal to the number of stator windings to produce a commutation period, said microcomputer producing commutation control signals at said output ports to cause the stator flux to rotate whereby switchings of said commutation devices are timed to occur at each zero-crossing of said back EMF signal and at intervals therebetween substantially equal to said commutation period.

11. A washing appliance pump according to claim 10 wherein said microcomputer is programmed to switch said commutation devices at intervals between said zero-crossings of said back EMF signal which are calculated as one third and two thirds respectively of said measure of half period time.

12. A washing appliance pump according to claim 10 wherein said microcomputer is programmed to provide said measure of half period time by calculating a moving average of successive measured times between pulse edges in said digitised signal which are due to zero-crossings.

13. A washing appliance pump according to claim 11 wherein said microcomputer is programmed to subtract a predetermined time from said calculated two thirds of said measure of half period time to produce an advanced time to switch said commutation devices at said advanced time.

14. A washing appliance pump according to claim 10 including:
freewheel diodes connected in parallel with each commutation device, a pulse width modulator which modulates said commutation switch control signals with a controllable duty cycle to vary the effective voltage applied from said direct current power supply to said stator windings, and wherein said microcomputer is programmed to:
(1) monitor the trailing edge of a pulse in the digitised back EMF due to current flowing through a free wheel diode when said sensed winding has been disconnected from said direct current supply,
(2) calculate the time interval between the trailing edge of said pulse and the next detected zero-crossing the in back EMF signal, and
(3) if said calculated time interval is less than a pre-stored value, altering the duty cycle of said pulse width modulation to reduce the voltage applied to said stator windings.

15. (canceled)

16. (canceled)

17. A method according to claim 2 wherein the 120° flux angle commutations are advanced by a predetermined time.

18. A method according to claim 3 wherein the 120° flux angle commutations are advanced by a predetermined time.

19. A motor according to claim 6 wherein said microcomputer is programmed to provide said measure of half period time by calculating a moving average of successive measured times between pulse edges in said digitised signal which are due to zero-crossings.

20. A motor according to claim 19 wherein said microcomputer is programmed to subtract a predetermined time from said calculated two thirds of said measure of half period time to produce an advanced time to switch said commutation devices at said advanced time.

21. A washing appliance pump according to claim 11 wherein said microcomputer is programmed to provide said measure of half period time by calculating a moving average of successive measured times between pulse edges in said digitised signal which are due to zero-crossings.

22. A washing appliance pump according to claim 21 wherein said microcomputer is programmed to subtract a predetermined time from said calculated two thirds of said measure of half period time to produce an advanced time to switch said commutation devices at said advanced time.
